(19) United States
(12) Patent Application Publication
(10) Pub. No.: US 2007/0132899 A1
(43) Pub. Date: Jun. 14, 2007

(54) Liquid crystal display panel

(75) Inventors: Yung-Chiang Cheng, Miao-Li (TW); Chin-Chang Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/636,736

(22) Filed: Dec. 11, 2006

(30) Foreign Application Priority Data
Dec. 9, 2005 (TW) 94143572

(51) Int. Cl. G02F 1/1343

(52) U.S. Cl. 349/38

(57) ABSTRACT

A liquid crystal display panel includes a plurality of scanning lines, a plurality of storage capacitor lines, a plurality of data lines intersected with the scanning lines, a plurality of first and second thin film transistors (TFTs) located in the vicinity of a crossing of a corresponding one of the scanning lines and a corresponding one of the data lines, a plurality of first pixel electrodes, and a plurality of first storage capacitors respectively connected to the first TFT, a plurality of second pixel electrodes, and a plurality of second storage capacitors respectively connected to the second TFT. The capacitances of the first storage capacitors are different from those of the second storage capacitors.

### BACKGROUND OF THE INVENTION

1. Field of the Invention

The invention relates to a liquid crystal display (LCD) panel, and particularly a multi-domain vertical alignment (MVA) LCD panel.

2. General Background

Liquid crystal display (LCD) panels have many advantages over other kinds of display apparatuses. For example, LCD panels are lightweight and thin, and have low power consumption. Thus LCD panels have been widely used in products such as TVs, notebooks (NBs), cell phones, personal computers (PCs), and personal digital assistants (PDAs). However, one disadvantage of a traditional LCD panel is its narrow viewing angle. In order to solve this problem, a wide viewing angle technique called “multi-domain vertical alignment (MVA)” was developed by Fujitsu Corporation. The MVA technique is to set several bumps (also known as protrusions) that serve as electrodes on each of upper and lower substrates of an LCD panel, whereby molecules of liquid crystal between the substrates are normally aligned vertical to the substrates. When a voltage is applied to the substrates, voltage differences in different directions are generated. That is, electrical lines of the electric field generated run along different directions. Accordingly, the molecules of liquid crystal are driven into alignment with the electrical lines along different directions. Light that passes through the differently aligned molecules of liquid crystal can provide compensated optical paths and phase with each other so as to provide a wide viewing angle.

Another new technique for increasing viewing angle is to divide what is conventionally a single pixel into two separate but adjacent sub-pixels. Different voltages are applied to the two sub-pixels. Accordingly, angles of deflection of molecules of liquid crystal in the two sub-pixels are different from each other. Hence, the optical paths and phases can be well compensated when light transmits through the molecules of liquid crystal of the two sub-pixels. Thereby, the viewing angle of the LCD panel is increased.

Referring to FIG. 5, this is a schematic, top plan view of part of a driving circuit of a two transistor type super patterned vertical alignment (TTPVA) LCD panel developed by Samsung Corporation. The driving circuit 100 includes a plurality of 1^{st} scan lines 101, a plurality of 2^{nd} scan lines 201, a plurality of data lines 102, a plurality of storage capacitor lines 103, a plurality of 1^{st} thin film transistors (TFTs) 104, a plurality of 2^{nd} TFTs, and a common electrode 107.

The 1^{st} scan lines 101 and 2^{nd} scan lines 201 are arranged in parallel with each other, and are each aligned along a first direction. The data lines 102 are arranged in parallel with each other, and are each aligned along a second direction perpendicular to the first direction. That is, the scan lines 101, 201 and data lines 102 cross each other so as to define a plurality of pixels 500. It is to be noted that the scan lines 101, 201 and the data lines 102 are electrically isolated from each other. The storage capacitor lines 103 are parallel to the scan lines 101, 201, and connect with the common electrode 107.

FIG. 6 is an enlarged view of an exemplary pixel 500 of the driving circuit 100. The 1^{st} TFT 104 is located in the vicinity of a crossing of a corresponding one of the 1^{st} scan lines 101 and a corresponding one of the data lines 102. A gate electrode 1040 of the 1^{st} TFT is connected with the 1^{st} scan line 101, and a source electrode 1041 of the 1^{st} TFT is connected with the data line 102. The 2 TFT 204 is located in the vicinity of a crossing of a corresponding one of the 2^{nd} scan lines 201 and the data line 102. A gate electrode 2040 of the 2^{nd} TFT is connected with the 2^{nd} scan line 201, and a source electrode 2041 of the 2^{nd} TFT is connected with the data line 102. The pixel 500 comprises a 1^{st} sub-pixel 501 and a 2^{nd} sub-pixel 502. The 1^{st} sub-pixel 501 includes a 1^{st} pixel electrode 106 connected to a drain electrode 1042 of the 1^{st} TFT 104, and a 1^{st} storage capacitor 109. The 2^{nd} sub-pixel 502 includes a 2^{nd} pixel electrode 206 connected to a drain electrode 2042 of the 2^{nd} TFT 204, and a 2^{nd} storage capacitor 209. A 1^{st} liquid crystal (LC) capacitor 108 is connected between the 1^{st} pixel electrode 106 and the common electrode 107. A 2^{nd} LC capacitor 208 is connected between the 2^{nd} pixel electrode 206 and the common electrode 107. Additionally, one end of the 1st storage capacitor 109 and one end of the 2nd storage capacitor 209 are each connected to the storage capacitor line 103.

Operation of the driving circuit 100 is described below with reference to the graphs of FIG. 7. Graph (A) is a plot of voltage of a signal coming from the data line 102. Graph (B) is a plot of voltage of a scan signal coming from the 1^{st} scan line 101. Graph (C) is a plot of voltage of a scan signal coming from the 2^{nd} scan line 201. Graph (D) is a plot of voltage of a signal coming from the 1^{st} pixel electrode 106. Graph (E) is a plot of voltage of a signal coming from the 2^{nd} pixel electrode 206.

At a point in time t₁ (corresponding to where the Time axis meets the Voltage axis), a 1^{st} scan voltage V_{g1} is applied by a scan driving device (not shown) through the 1^{st} scan line 101 to drive the gate electrode 1040 of the 1^{st} TFT 104, as shown in graph (B). At the same time, a 2^{nd} scan voltage V_{g2} is applied by the scan driving device through the 2^{nd} scan line 201 to drive the gate electrode 2040 of the 2^{nd} TFT 204, as shown in graph (C). Thereby, the 1^{st} TFT 104 and the 2^{nd} TFT 204 are turned on. In addition, at the same time, a data voltage V_{dh} is applied by a data line driving device (not shown) through the data line 102 to the source electrode 1041 of the 1^{st} TFT 104 and the source electrode 2041 of the 2^{nd} TFT 204, so as to charge the 1^{st} LC capacitor 108, the 2^{nd} LC capacitor 208, the 1^{st} storage capacitor 109, and the 2^{nd} storage capacitor 209.

At a point in time t₂, the 1^{st} LC capacitor 108, the 2^{nd} LC capacitor 208, the 1^{st} storage capacitor 109, and the 2^{nd} storage capacitor 209 are all charged to the voltage V_{dh}. At this point, the data line drives device to stop applying the data voltage V_{dh}, and the scan driving device stops applying the scan voltage V_{g1} to the 1^{st} TFT 104 so as to turn off the 1^{st} TFT 104. The voltages of the 1^{st} LC capacitor 108 and the 1^{st} storage capacitor 109 remain at V_{dh} until a point in time of starting a next scan period, namely time t₄. At time t₂, the scan driving device continues to apply the 2^{nd} scan voltage V_{g2} to the 2^{nd} TFT 204 so as to keep the 2^{nd} TFT 204 turned on. Therefore, the 2^{nd} LC capacitor 208 and the 2^{nd} storage capacitor 209 are discharged through the drain electrode 2042 and the source electrode 2041 of the 2^{nd} TFT 204. At a point in time t₃, the voltages of the 2^{nd} LC capacitor 208 and the 2^{nd} storage capacitor 209 are both discharged to a voltage level V_{d1}. At this time, the scan driving device stops applying the 2^{nd} scan voltage V_{g2} to the 2^{nd} TFT 204, and the voltages of the 2^{nd} LC capacitor 208 and the 2^{nd} storage capacitor 209 remain at V_{d1} until time t₄.

The voltage of each of the 1^{st} and 2^{nd} LC capacitors 108, 208 is the working voltage of the corresponding 1^{st} and 2^{nd} sub-pixels 501, 502. That is, the working voltages of the 1^{st} and 2^{nd} sub-pixels 501, 502 are the voltages V_{dh} and V_{d1} of the 1^{st} LC capacitor 108 and the 2^{nd} LC capacitor 208 respectively. V_{dh} and V_{d1} are not the same. That is, the working voltage of the 1^{st} sub-pixel 501 is different from the working voltage of the 2^{nd} sub-pixel 502. The driving circuit 100 has certain disadvantages. Two scan lines 101, 201 are needed to drive each one pixel 500. That is, the driving circuit 100 needs to be configured with numerous scan lines 101, 201. Additionally, the scan lines 101, 201 are typically made of opaque metallic material. Therefore the aperture ratio of the LCD panel is relatively low.

### SUMMARY

An exemplary liquid crystal display panel includes a 1^{st} substrate, a 2^{nd} substrate, and a liquid crystal layer. The 1^{st} substrate includes a plurality of scan lines, a plurality of storage capacitor lines, a plurality of data lines, a plurality of 1^{st} thin film transistors (TFTs), a plurality of 2^{nd} TFTs, a plurality of 1^{st} pixel electrodes, a plurality of 2^{nd} pixel electrodes, a plurality of 1^{st} storage capacitors, and a plurality of 2^{nd} storage capacitors. The scan lines are arranged parallel with each other. The storage capacitor lines are arranged parallel with each other, and intervened between each of the scan lines. The data lines arrange vertically and isolate to the scan lines and the storage capacitor lines. The 1^{st} and 2^{nd} TFTs are located on the opposite side of the scan lines and being adjacent to data lines, each gate electrode of the 1^{st} and 2^{nd} TFTs connect to the scan lines respectively and each source electrode of the 1^{st} and 2^{nd} TFTs connect to the data lines. The 1^{st} and 2^{nd} pixel electrodes connect to the drain electrodes of each 1^{st} and 2^{nd} TFTs respectively. Each end of the 1st and 2nd storage capacitors connect to each drain electrodes of the 1^{st} and 2^{nd} TFTs respectively, the other end of the 1^{st} and 2^{nd} storage capacitors connect to the storage capacitor lines.

It is to be noted that capacitances of the 1^{st} and 2^{nd} storage capacitors are different from each other. The 2^{nd} substrate is set opposite to the 1^{st} substrate. The liquid crystal layer is interposed between the 1^{st} substrate and the 2^{nd} substrate. In the preferred embodiment, the capacitance of the 1^{st} storage capacitor is smaller (or larger) than capacitance of the 2^{nd} storage capacitor. Furthermore, the 2^{nd} substrate includes a common electrode. The 1^{st} liquid crystal capacitors and 2^{nd} liquid crystal capacitors are composed respectively by the 1^{st} and 2^{nd} pixel electrodes with the common electrode.

A detailed description of embodiments of the present invention is given below with reference to the accompanying drawings. In the drawings, all the views are schematic.

### BRIEF DESCRIPTION OF THE DRAWINGS

FIG. 1 is an abbreviated, isometric view of a liquid crystal display (LCD) panel in accordance with a preferred embodiment of the present invention.

FIG. 2 is a top plan view of part of a driving circuit of the LCD panel of FIG. 1.

FIG. 3 is an enlarged view of an exemplary pixel of the driving circuit of FIG. 2.

FIG. 4 includes four graphs of voltage varying according to time, which illustrate certain aspects of operation of the driving circuit of FIG. 2.

FIG. 5 is a schematic, top plan view of part of a driving circuit of a conventional liquid crystal display panel.

FIG. 6 is an enlarged view of an exemplary pixel of the driving circuit of FIG. 5.

FIG. 7 includes five graphs of voltage varying according to time, which illustrate certain aspects of operation of the driving circuit of FIG. 5.

### DETAILED DESCRIPTION OF PREFERRED EMBODIMENTS

Referring to FIG. 1, this is an abbreviated, isometric view of a liquid crystal display (LCD) panel in accordance with a preferred embodiment of the present invention. The LCD panel 1 includes a first substrate 2, a second substrate 3, and a liquid crystal (LC) layer 4. The first substrate 2 and the second substrate 3 are set opposite to each other, with the LC layer 4 interposed therebetween. Additionally, a common electrode 17 is set on the first substrate 2, and a driving circuit 10 is set on the second substrate 3.

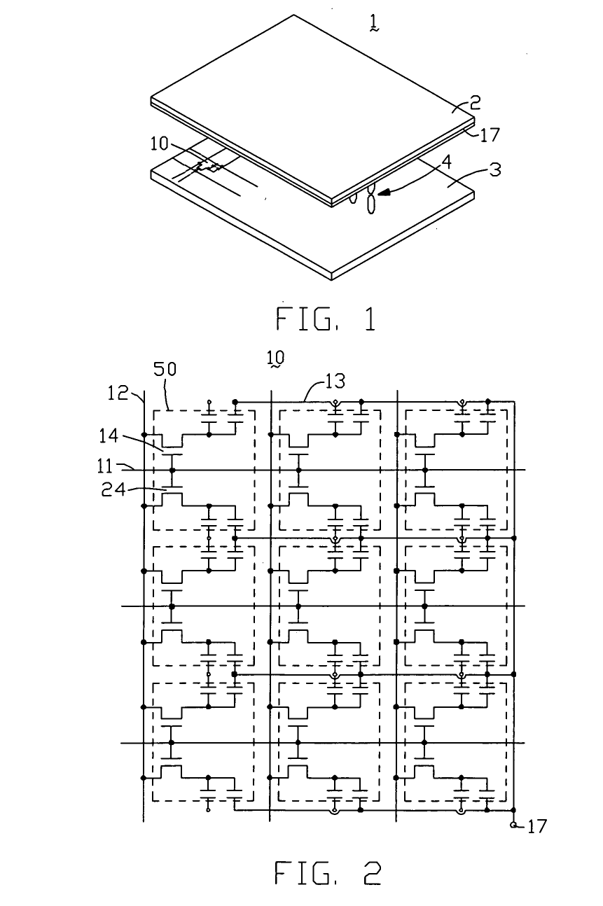

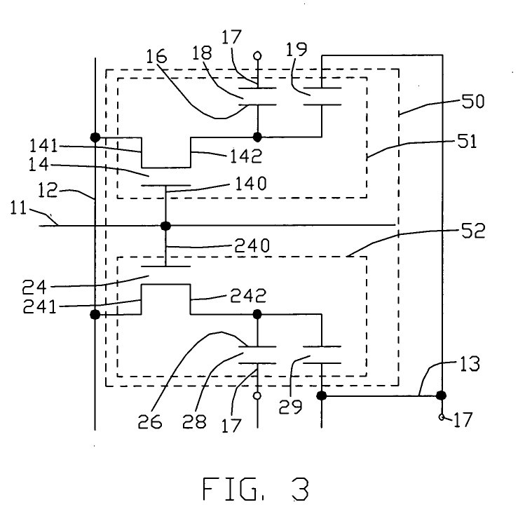

FIG. 2 is a top plan view of part of the driving circuit 10. The driving circuit 10 includes a plurality of scan lines 11, a plurality of data lines 12, a plurality of storage capacitor lines 13, a plurality of first thin film transistors (TFTs) 14, and a plurality of second TFTs 24. The scan lines 11 are arranged in parallel with each other, and are each aligned along a first direction. The data lines 12 are arranged in parallel with each other, and are each aligned along a second direction perpendicular to the first direction. The data lines 12 are isolated from the scan lines 11. The storage capacitor lines 13 and the scan lines 11 are arranged parallel to each other and alternately relative to each other. Furthermore, the storage capacitor lines 13 connect with the common electrode 17. Moreover, areas between where the storage capacitor lines 13 intersect with the data lines 12 are defined as a plurality of pixels 50.

Referring to FIG. 3, this is an enlarged view of an exemplary pixel 50 of the driving circuit 10. The first and second TFTs 14 and 24 are set in the vicinity of an intersection of the corresponding scan line 11 and the corresponding data line 12. The gate electrodes 140 and 240 of the first and second TFTs 14 and 24 are connected to the scan line 11. The source electrodes 141 and 241 of the first and second TFTs 14 and 24 are connected to the data line 12. The first and second TFTs 14 and 24 are also known as switching devices, which are controlled (to “turn on” or “turn off”) by signals coming from the data line 12.

Each pixel 50 has a first sub-pixel 51 and a second sub-pixel 52. The first sub-pixel 51 includes a first storage capacitor 19 and a first pixel electrode 16, each connecting to the drain electrode 142 of the first TFT 14. The second sub-pixel 52 includes a second storage capacitor 29 and a second pixel electrode 26, each connecting to the drain electrode 242 of the second TFT 24. Furthermore, a first liquid crystal (LC) capacitor 18 and a second LC capacitor 28 are formed by the first pixel electrode 16 and the common electrode 17 and by the second pixel electrode 26 and the common electrode 17 respectively. The other end of the first storage capacitor 19 and the other end of the second storage capacitor 29 respectively connect to corresponding storage capacitor lines 13. It should be noted that the capacitances of the first storage capacitor 19 and the second storage capacitor 29 are different from each other. In the preferred embodiment, in order to achieve the different capacitances of the first and second storage capacitors, 19, 29, several structural approaches can be adopted. For example, the metal coupling areas can be configured accordingly, the distance between coupling metal pieces can be configured accordingly, the particular metallic materials (with different dielectric constants) of the coupling metal pieces can be configured accordingly, etc.

During the process of manufacturing TFTs, unwanted parasitic capacitors are almost inevitably created as a byproduct. Generally, a typical TFT should be considered as an ideal TFT combined with a parasitic capacitor connected in parallel with the ideal TFT. In order to set the first sub-pixel 51 and the second sub-pixel 52 to function at different working voltages, the different capacitances of the storage capacitors 19 and 26 are provided.

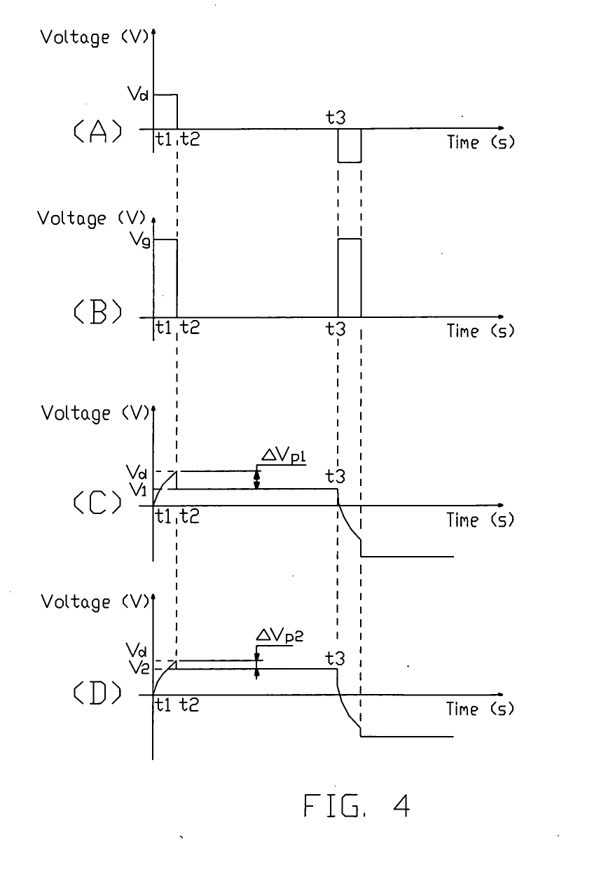

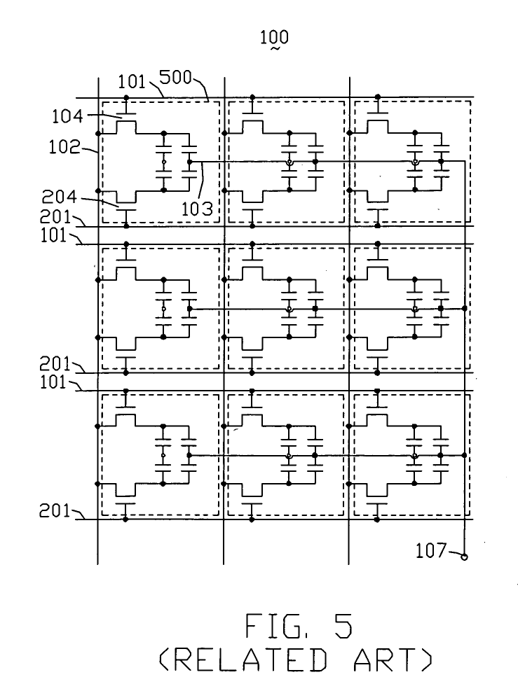

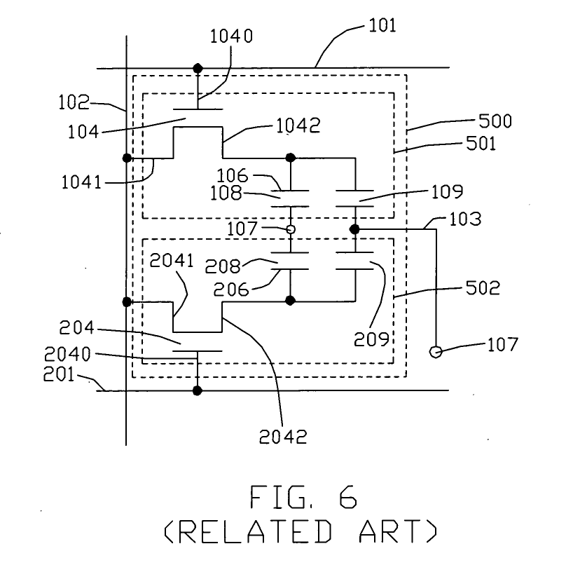

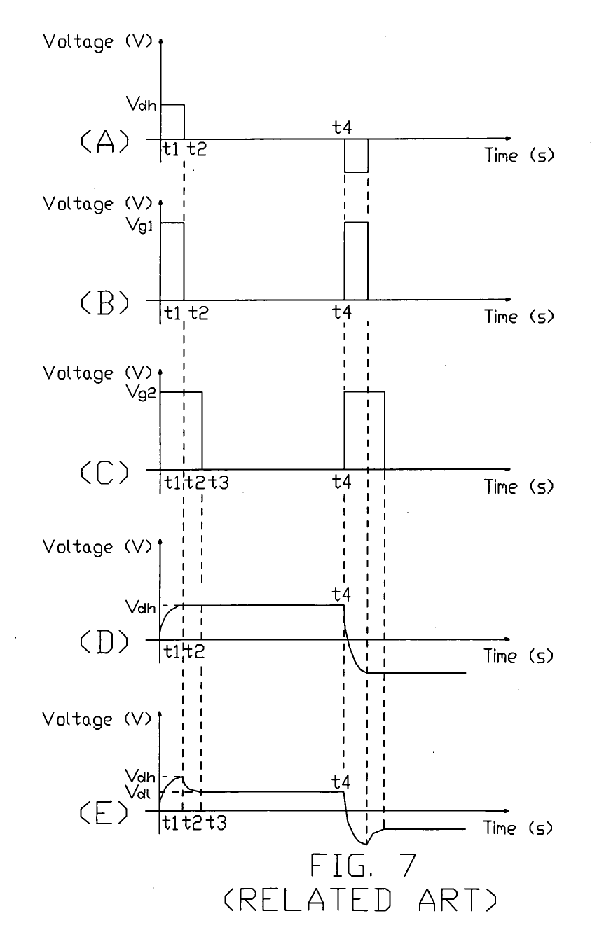

Operation of the driving circuit 10 is described below with reference to the graphs of FIG. 4. Graph (A) is a plot of voltage of a signal coming from the data line 12. Graph (B) is a plot of voltage of a scan signal coming from the scan line 11. Graph (C) is a plot of voltage of a signal coming from the first sub-pixel 51. Graph (D) is a plot of voltage of a signal coming from the second sub-pixel 52. At a point in time t₁, as shown in Graph (A), a scan voltage V_{g} is provided by the scan line 11. Thereby, both the first TFT 14 (where the capacitance of the parasitic capacitor is C_{gd1}) and the second TFT 24 (where the capacitance of the parasitic capacitor is C_{gd2}) are turned on. At the same time, a voltage signal V_{d} provided by the data line 12 is provided through the first TFT 14 and the second TFT 24. Thereby, the first LC capacitor 18, the first storage capacitor 19, the second LC capacitor 28, and the second storage capacitor 29 are all charged. The capacitances of these four capacitors 18, 19, 28, 29 are C_{lc1}, Cₛₜ₁, C_{lc2}, and Cₛₜ₂ respectively.

At a point in time t₂, as shown in Graph (B), the voltages of the four capacitors 18, 19, 28, 29 are all charged to V_{d}; and the voltages of the parasitic capacitors (not shown) of the first and second TFTs 14 and 24 are both charged to V_{g}−V_{d}, which is the voltage difference between the gate electrode 140, 240 and the source electrode 141, 241 of the first and second TFTs 14, 24, respectively. At this time, the scan line 11 and the data line 12 stop driving, Thereby, the first and second TFTs 14 and 24 are turned off, and simultaneously the voltages of the gate electrodes 140, 240 become zero. The voltage differences of the parasitic capacitors change correspondingly. It should be noted that partial electric charges coming from the parasitic capacitor of the first TFT 14 flow to the first LC capacitor 18 and the first storage capacitor 19, so that a kickback voltage (ΔVₚ₁) is generated from the first LC capacitor 18 and the first storage capacitor 19. As shown in Graph (C), the voltage of the first LC capacitor 18 and the first storage capacitor 19 becomes the voltage V₁. Correspondingly, the voltage of the parasitic capacitor of the first TFT 14 is changed to the voltage −V₁. The voltages V₁ and −V₁ are maintained until the start time t₃ of the next scan period.

Additionally, partial electric charges coming from the parasitic capacitor of the second TFT 24 flow to the second LC capacitor 28 and the second storage capacitor 29, so that a kickback voltage (ΔVₚ₂) is generated from the second LC capacitor 28 and the second storage capacitor 29. As shown in Graph (D), the voltage of the second LC capacitor 28 and the second storage capacitor 29 becomes the voltage V₂. Correspondingly, the voltage of the parasitic capacitor of the second TFT 24 is changed to the voltage −V₂. The voltages V₂ and −V₂ are maintained until time t₃.

In accordance with the law of conservation of charge, the values of the kickback voltages ΔVₚ₁ and ΔVₚ₂ are as follows:

$$\begin{matrix}Δ {V}_{p 1} = \frac{( {V}_{g} - {V}_{d} + {V}_{1} ) {C}_{gd 1}}{{C}_{lc 1} + {C}_{st 1}} & ( 1 ) \\ Δ {V}_{p 2} = \frac{( {V}_{g} - {V}_{d} + {V}_{2} ) {C}_{gd 2}}{{C}_{lc 2} + {C}_{st 2}} & ( 2 )\end{matrix}$$

The values of the working voltages V₁ and V₂ of the first and second sub-pixels 51 and 52 are as follows:
V₁=V_{d}−ΔV_{p1tm (}3)
V₂=V_{d}−ΔVₚ₂ (4)
According to equations (1)˜(4), ΔVₚ₁ and ΔVₚ₂ can be calculated as follows:

$$\begin{matrix}Δ {V}_{p 1} = \frac{{V}_{g} {C}_{gd 1}}{{C}_{gd 1} {C}_{lc 1} + {C}_{st 1}} & ( 5 ) \\ Δ {V}_{p 2} = \frac{{V}_{g} {C}_{gd 2}}{{C}_{gd 2} + {C}_{lc 2} + {C}_{st 2}} & ( 6 )\end{matrix}$$

As described in the foregoing equations (3)˜(6), by adjusting the capacitances of the first storage capacitor 19 and the second storage capacitor 29, the different kickback voltages ΔVₚ₁ and ΔVₚ₂ are thereby obtained. Accordingly, the working voltages V₁ and V₂ of the first and second sub-pixels 51 and 52 are different from each other. Due to the first and second TFTs 14 and 24 having essentially the same structure, the capacitances C_{gd1} and C_{gd2} of the individual accompanying parasitic capacitors can be assumed to be the same. Furthermore, the first and second LC capacitors 18 and 28 have essentially the same structure, so that the capacitances C_{lc1}, and C_{lc2} thereof are assumed to be identical to each other. Therefore, providing the different capacitances Cₛₜ₁ and Cₛₜ₂ of the first and second storage capacitors 19 and 29 so that different kickback voltages ΔVₚ₁ and ΔVₚ₂ can be obtained achieves the object of attaining different working voltages V₁ and V₂ of the first and second sub-pixels 51 and 52. In the preferred embodiment, the capacitance of the first storage capacitor 19 can be configured to be either less or more than the capacitance of the second storage capacitor 29, so as to achieve the object of attaining the different working voltages V₁ and V₂ of the first and second sub-pixels 51 and 52.

As would be understood by a person skilled in the art, the foregoing description of preferred and exemplary embodiments is intended to be illustrative of principles of the present invention rather than being limiting. The description is intended to cover various modifications and similar arrangements included within the spirit and scope of the appended claims, the scope of which should be accorded the broadest interpretation so as to encompass all such modifications and similar structures.

We claim:

1. A liquid crystal panel, comprising:
a plurality of scan lines, arranged in parallel with each other;
a plurality of storage capacitor lines, arranged in parallel with each other and said scan lines, and being arranged alternately with said scan lines;
a plurality of data lines, arranged in parallel with each other, and crossing and being isolated from said scan lines and said storage capacitor lines;
a plurality of first thin film transistors (TFTs) and a plurality of second TFTs arranged in pairs, the first TFT and the second TFT of each pair of TFTs being located at opposite sides of a corresponding one of said scan lines and being adjacent to a corresponding one of said data lines, gate electrodes of the first and second TFTs connecting to the corresponding scan line respectively, source electrodes of the first and second TFTs connecting to the corresponding data line respectively;
a plurality of first pixel electrodes and a plurality of second pixel electrodes arranged in pairs corresponding to the pairs of TFTs, the first pixel electrode and the second pixel electrode of each pair of pixel electrodes connecting to drain electrodes of the first and second TFTs of the corresponding pair of TFTs respectively; and
a plurality of first storage capacitors and a plurality of second storage capacitors arranged in pairs corresponding to the pairs of TFTs, first ends of the first and second storage capacitors of each pair of storage capacitors connecting to the drain electrodes of the first and second TFTs of the corresponding pair of TFTs respectively, second ends of the first and second storage capacitors of each pair of storage capacitors connecting to two corresponding adjacent of the storage capacitor lines respectively;
wherein capacitances of the first and second storage capacitors of each pair of storage capacitors are different from each other.

2. The liquid crystal panel as claimed in claim 1, wherein a capacitance of the first storage capacitor of each pair of storage capacitors is less than that of the second storage capacitor of that pair of storage capacitors.

3. The liquid crystal panel as claimed in claim 1, wherein a capacitance of the first storage capacitor of each pair of storage capacitors is greater than that of the second storage capacitor of that pair of storage capacitors.

4. A liquid crystal display panel, comprising:
a first substrate, comprising:
a plurality of scan lines, arranged in parallel with each other;
a plurality of storage capacitor lines, arranged in parallel with each other and said scan lines, and being arranged alternately with said scan lines;
a plurality of data lines, arranged in parallel with each other, and crossing and being isolated from said scan lines and said storage capacitor lines;
a plurality of first thin film transistors (TFTs) and a plurality of second TFTs arranged in pairs, the first TFT and the second TFT of each pair of TFTs being located at opposite sides of a corresponding one of said scan lines and being adjacent to a corresponding one of said data lines, gate electrodes of the first and second TFTs connecting to the corresponding scan line respectively, source electrodes of the first and second TFTs connecting to the corresponding data line respectively;
a plurality of first pixel electrodes and a plurality of second pixel electrodes arranged in pairs corresponding to the pairs of TFTs, the first pixel electrode and the second pixel electrode of each pair of pixel electrodes connecting to drain electrodes of the first and second TFTs of the corresponding pair of TFTs respectively; and
a plurality of first storage capacitors and a plurality of second storage capacitors arranged in pairs corresponding to the pairs of TFTs, first ends of the first and second storage capacitors of each pair of storage capacitors connecting to the drain electrodes of the first and second TFTs of the corresponding pair of TFTs respectively, second ends of the first and second storage capacitors of each pair of storage capacitors connecting to two corresponding adjacent of the storage capacitor lines respectively;
wherein capacitances of the first and second storage capacitors of each pair of storage capacitors are different from each other;
a second substrate set opposite to said first substrate; and
a liquid crystal layer between said first substrate and said second substrate.

5. The liquid crystal display panel as claimed in claim 4, wherein a capacitance of the first storage capacitor of each pair of storage capacitors is less than that of the second storage capacitor of that pair of storage capacitors.

6. The liquid crystal display panel as claimed in claim 4, wherein a capacitance of the first storage capacitor of each pair of storage capacitors is greater than that of the second storage capacitor of that pair of storage capacitors.

7. The liquid crystal display panel as claimed in claim 4, wherein said second substrate comprises a common electrode.

8. The liquid crystal display panel as claimed in claim 7, wherein said first pixel electrodes and second pixel electrodes and said common electrode form a plurality of first liquid crystal capacitors and a plurality of second liquid crystal capacitors respectively.

9. A liquid crystal panel, comprising:
a plurality of scan lines, arranged in parallel with each other;
a plurality of storage capacitor lines, arranged in parallel with each other and said scan lines, and being arranged alternately with said scan lines;
a plurality of data lines, arranged in parallel with each other, and crossing both said scan lines and said storage capacitor lines;
a plurality of first thin film transistors (TFTs) and a plurality of second TFTs arranged in pairs, the first TFT and the second TFT of each pair of TFTs being located at opposite sides of a corresponding one of said scan lines and being adjacent to a corresponding one of said data lines, gate electrodes of the first and second TFTs connecting to the common corresponding scan line respectively, source electrodes of the first and second TFTs connecting to the corresponding data line respectively.

10. The liquid crystal panel as claimed in claim 9, further including a plurality of first pixel electrodes and a plurality of second pixel electrodes arranged in pairs corresponding to the pairs of TFTs, the first pixel electrode and the second pixel electrode of each pair of pixel electrodes connecting to drain electrodes of the first and second TFTs of the corresponding pair of TFTs respectively.

11. The liquid crystal panel as claimed in claim 9, further including a plurality of first storage capacitors and a plurality of second storage capacitors arranged in pairs corresponding to the pairs of TFTs, first ends of the first and second storage capacitors of each pair of storage capacitors connecting to the drain electrodes of the first and second TFTs of the corresponding pair of TFTs respectively, second ends of the first and second storage capacitors of each pair of storage capacitors connecting to two corresponding adjacent of the storage capacitor lines respectively.

12. The liquid crystal panel as claimed in claim 9, wherein capacitances of the first and second storage capacitors of each pair of storage capacitors are different from each other.
